(19) United States
(12) Patent Application Publication
(10) Pub. No.: US 2023/0351303 A1
(43) Pub. Date: Nov. 2, 2023

(54) METHOD FOR AUDITING THE HEALTH OF A NON-PROFIT ORGANIZATION

(71) Applicant: Dextrous Consulting LLC, Golden, CO (US)

(72) Inventor: Tyson Noeth, Golden, CO (US)

(21) Appl. No.: 18/141,736

(22) Filed: May 1, 2023

Related U.S. Application Data
(60) Provisional application No. 63/336,649, filed on Apr. 29, 2022.

(51) Int. Cl. G06Q 10/0639

(52) U.S. Cl. CPC G06Q 10/06393

(57) ABSTRACT

There is disclosed a method for auditing and automatically scoring an operational health of a non-profit organization providing services according to a mission. The organization may have a board of directors providing governance and a staff providing the services. A respondent of the organization may be presented with audit questions configured to measure the impact of certain health markers on the health and may be based on sustainability research. Each of the health markers may refer to a behavior or an expertise within the organization. Audit answers corresponding to the audit questions may be received from the respondent. The method may further comprise quantifying and scaling each of the audit answers in proportion to their influence on the operational health. The scaled audit answers may be combined to produce a composite sustainability score of the operational health. An indication of the composite score may be electronically sent to the organization.

### CROSS REFERENCE TO RELATED APPLICATIONS

This patent application claims priority to U.S. Provisional Application No. 63/336,649 filed on Apr. 29, 2022 and entitled METHOD FOR AUDITING THE HEALTH OF A NON-PROFIT ORGANIZATION, the entire contents of Application 63/336,649 being expressly incorporated by reference herein.

### BACKGROUND

Non-profit organizations (NPO) may struggle to fulfill a mission, be ineffectual at the mission, or fail prematurely. The volunteer nature of the organization, and the complexity that community stakeholders introduce, may attract unique hindrances that threaten its sustainability, such as an inappropriate governance model, poor communications, not budgeting for continuing education, and a lack of the corrective feedback which for-profit businesses enjoy. The organization may lack skills in areas such as marketing, finance, business leadership, community relations, and program development.

One solution to an unhealthy non-profit is to hire in-person consultants that meet with members of its staff and the board of directors (BOD) for manually auditing an operational health. Improved processes or standards may be thereby recommended. However, this may be expensive for a donation-based organization, and there may be internal resistance to change if it's a ‘top-down’ approach. Also, once the consulting ends, the organization may not sustain the initial momentum for change.

One common mechanism for attracting funding and staff to the non-profit organization is to network with local business organizations and other non-profits and to seek the opinions of others in the local community. However, this opinion-seeking tends to be overly subjective. Personnel and donations may temporarily enliven the organization and its mission one year, only to disappear in the following year, creating significant turnover and financial instability.

A non-profit that has paid for consultants and then strayed from their recommended processes and standards may lack the management skills to track the health markers that correlate to operational health. Having to rehire the consultants is not only costly, but probably indicates that a degradation in community relations and client services has already occurred.

### SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In an embodiment, there is disclosed a method for auditing and automatically scoring an operational health of a non-profit organization (NPO) providing services according to a mission. The organization may have a board of directors (BOD) for providing governance and a staff for providing the services. The method may comprise presenting to a respondent of the organization a series of audit questions configured to measure the impact of certain health markers on the operational health of the organization. The audit questions may be based on sustainability research.

Each of the health markers may refer to an operational behavior or an expertise within the organization. The method may further comprise receiving from the respondent audit answers corresponding to the series of audit questions. The method may further comprise quantifying and scaling each of the audit answers in proportion to their influence on the operational health. The scaled audit answers may be combined to produce a composite sustainability score of the operational health. The method may further comprise electronically sending an indication of the composite score to the organization. The composite sustainability score may predict an ability of the organization to indefinitely sustain its mission.

In a further embodiment, there is disclosed an audit system for auditing and automatically scoring an operational health of a non-profit organization (NPO) providing services according to a mission. The organization may have a board of directors (BOD) for providing governance and a staff for coordinating with the BOD to provide the services according to the mission. The system may comprise a user interface configured for communicating with a respondent associated with the organization. The system may further comprise an audit processor configured to electronically send audit questions to and receive corresponding audit answers from the respondent through the user interface. The audit questions may be for measuring the impact of certain health markers on the operational health and based on the sustainability research. Each of the audit answers may illuminate an operational behavior and/or an expertise within the organization.

The system may further comprise an organizational database connected to the audit processor and configurable to store organizational descriptors. The organizational descriptors may be for classifying the organization and other NPOs having a similar organization type. A sustainability research library may be connected to the audit processor and may be configured to store the sustainability research. The research may include a correlation between the health markers indicative of the operational health and a history of mission sustainability for each of the other NPOs.

The system may further include a scoring calculator within the audit processor and may be configurable to quantify, scale, and combine the audit answers for producing a composite sustainability score quantifying the operational health. The organizational descriptors may include one or more of an annual operating budget, years of operation, a title of the organization, a non-profit legal status, services provided, an area of focus or mission, a governance model of the BOD, a number of paid staff, a number of volunteer staff, and a location of headquarters.

Additional objects, advantages and novel features of the technology will be set forth in part in the description which follows, and in part will become more apparent to those skilled in the art upon examination of the following, or may be learned from practice of the technology.

### BRIEF DESCRIPTION OF THE DRAWINGS

Non-limiting and non-exhaustive embodiments of the present invention, including the preferred embodiment, are described with reference to the following figures, wherein like reference numerals refer to like parts throughout the various views unless otherwise specified. Illustrative embodiments of the invention are illustrated in the drawings, in which:

FIG. 1 illustrates a block diagram of an audit system for scoring an operational health of a non-profit organization, in accordance with an embodiment of the present disclosure.

FIG. 2 illustrates a flowchart of a method for auditing the operational health of the non-profit organization, in accordance with an embodiment of the present disclosure.

FIG. 3 illustrates a flowchart for multiple respondents auditing the operational health of the non-profit organization, in accordance with an embodiment of the present disclosure.

FIG. 4 illustrates an appearance of a user interface for auditing the operational health of the non-profit organization, in accordance with an embodiment of the present disclosure.

FIGS. 5a-5c illustrate audit checkboxes for auditing the operational health of the non-profit organization, in accordance with an embodiment of the present disclosure.

FIG. 6 illustrates a list of marker categories for auditing the operational health of the non-profit organization, in accordance with an embodiment of the present disclosure.

FIG. 7 describes a research summary of category failures for auditing the operational health of the non-profit organization, in accordance with an embodiment of the present disclosure.

FIG. 8 lists sample audit questions for auditing the operational health of the non-profit organization, in accordance with an embodiment of the present disclosure.

FIG. 9 illustrates a screenshot of a BOD survey for auditing the operational health of the non-profit organization, in accordance with an embodiment of the present disclosure.

FIG. 10 describes example health markers and corresponding audit questions for auditing the operational health of the non-profit organization, in accordance with an embodiment of the present disclosure.

FIG. 11 illustrates a flowchart of a tiered process for auditing the operational health of the non-profit organization, in accordance with an embodiment of the present disclosure.

FIG. 12 illustrates a map of improving operational health for auditing the operational health of the non-profit organization, in accordance with an embodiment of the present disclosure.

FIG. 13 describes a seal of approval for auditing the operational health of the non-profit organization, in accordance with an embodiment of the present disclosure.

### DETAILED DESCRIPTION

Embodiments are described more fully below in sufficient detail to enable those skilled in the art to practice the system and method. However, embodiments may be implemented in many different forms and should not be construed as being limited to the embodiments set forth herein. The following detailed description is, therefore, not to be taken in a limiting sense.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

As may be appreciated, based on the disclosure, there exists a need in the art for an inexpensive, online audit system for non-profit organizations which identifies operational behaviors and standards posing a risk to the mission, based on sustainability research. Also, there exists a need in the art for an audit system that can quantify a composite health score for the organization. Additionally, there exists a need in the art for an audit system that can leverage the sustainability research to explain why certain health markers impact sustainability, and that can recommend processes and standards for improving the operational health. Further, there exists a need in the art for an audit system that can provide certification of the operational health to the public, and which can send maintenance messages to encourage agreed-upon improvements to be maintained.

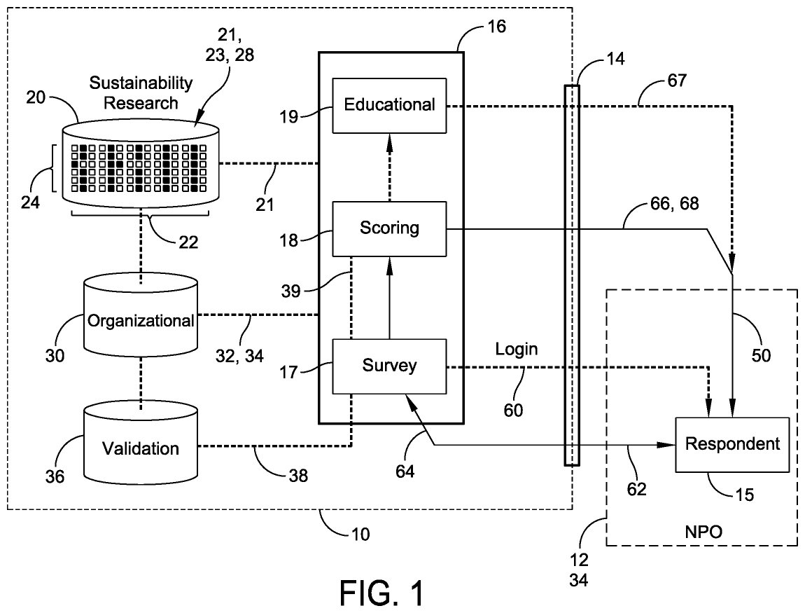

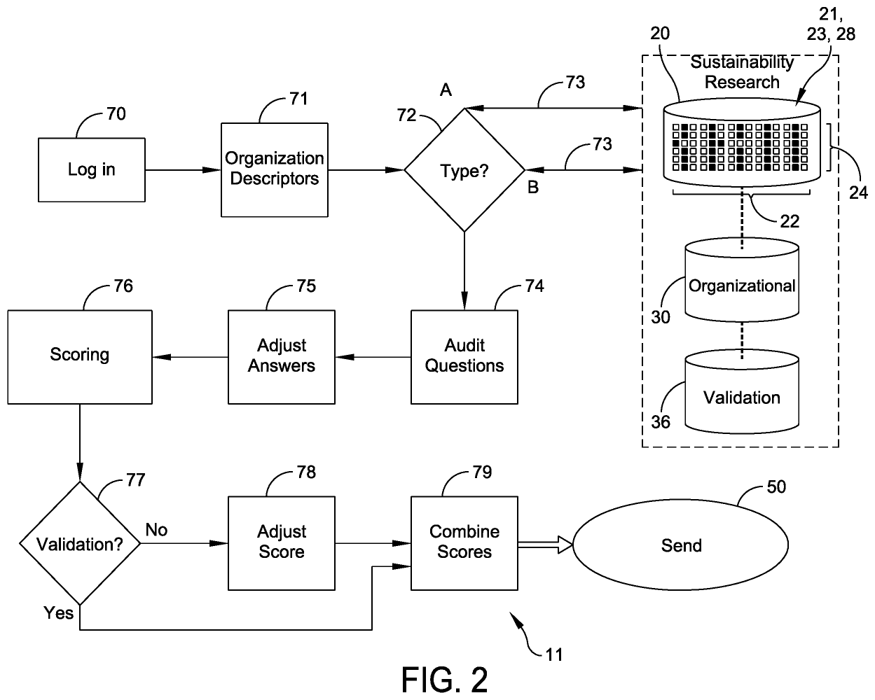

In various embodiments, an audit method 11 (FIG. 2) and system 10 (FIG. 1) are described for auditing and automatically scoring an operational health of a non-profit organization 12 providing services according to a mission. The organization 12 may include a board of directors (BOD) providing governance and a staff coordinating with the BOD to provide the services. The operational health may be defined as an ability to fulfill the mission indefinitely, and the audit method 11 may predict that sustainability. The operational health may also indicate an efficiency of the organization 12.

Referring to FIGS. 1-2 and 4, in various embodiments, a respondent 15 within, or a constituent of, the organization 12 may be presented 74 with a series of audit questions 62 through a user interface 14 connected to an audit processor 16 and configured to electronically communicate with the respondent 15. The respondent 15 may receive a login invite code 60 for accessing the audit questions 62 or may proactively seek out the audit system 10 and log in 70. The audit processor 16 may include a survey manager 17 configured to receive audit answers 64 corresponding to the audit questions 62 and from the respondent 15.

Each of the audit questions 62 may be configured to measure the impact of one or more health markers 22 on the operational health of the organization 12, the health markers based on sustainability research 21. The health markers 22 may refer to an operational behavior or an expertise within the organization 12, and may point to a skill, a process, a document, a condition, a role, an experience level, an event, an activity, or other aspect of the day-to-day operation of the organization. The health markers 22 may therefore tend to be dynamic in nature (e.g. “How often does your organization produce a variance report?”).

Continuing with FIGS. 1-2, in various embodiments, an organizational database 30 may be connected to the audit processor 16 and be configurable to store organizational descriptors 32 for classifying the organization 12 and other NPOs having a similar organization type 34. The audit questions 62 may include requesting 71 one or more of the following descriptors 32 in order to optimize the audit question 62 for the organization: an annual operating budget, years of operation, a title of the organization, a non-profit legal status, services provided, an area of focus or mission, a governance model of the BOD, a number of paid staff, a number of volunteer staff, and a location of headquarters. The descriptors 32 may tend to be static in nature (e.g. “What is the non-profit's legal status?”).

Continuing, once a respondent 15 has logged in 70 to take the audit, ‘step 1’ of the audit may consist of asking 71 the respondent 15 for the organizational descriptors 32, which may be followed by identifying 72 the organizational type 34 and drawing 73 the optimal audit questions 62 from the sustainability research 21 storable within research database 20. In other embodiments, audit querying 74 about operational behavior and expertise may be intermingled with some type requests 72 when corrections can later complete any adjustments for the correct organizational type 34.

Referring now to FIGS. 1-2 and 6-7, in various embodiments, the sustainability research library 20 may be connected to the audit processor 16 and the organizational database 30 and may be configured to store the sustainability research 21. The research 21 may include a correlation 28 (FIG. 1) between the health markers 22, indicative of the operational health, and a history 26 of mission sustainability. The audit 11 may include collecting the research 21 on a large number of the other NPOs similar to the non-profit organization 12. A range of impact for each of the health markers 22 may be correlated with the sustainability history 26 for each of a large number of NPOs of differing types 34. The range of impact may be used to select audit questions 62 for the audit of the organization 12 and may be used to weight each of the selected marker's 22 for the scoring of the operational health.

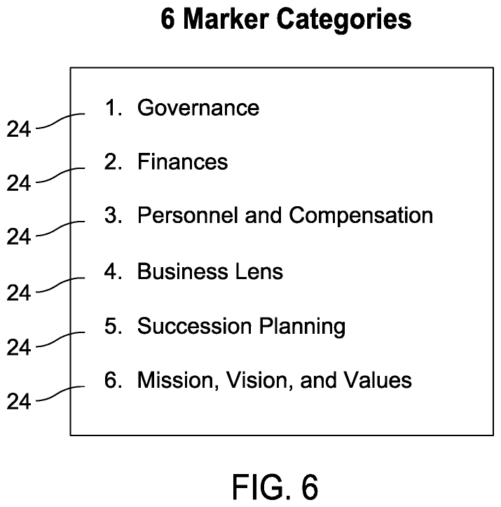

Continuing with FIGS. 1-2, 6-7, and 10, in various embodiments, the method may include grouping most or all of the health markers 22 into two or more of the marker categories 24 for collectively assessing the operational health while providing discrimination between different areas of behavior and expertise. In the embodiment of FIG. 6, there may be 6 categories which an effective health audit may include: 1) governance, 2) finances, 3) personnel and compensation, 4) managing the organization through a business lens, 5) succession planning, and 6) mission, vision, and values. Alternatively, a larger or smaller number of categories 24 may provide the most discriminating aggregation of health markers 22. For example, marker categories 24 may include one or more of the following: organizational alignment, strategic financial investment, financial diversification and funding stability, evidence of an innovative culture, and other categories identified by the Colorado organization Aging Dynamics.

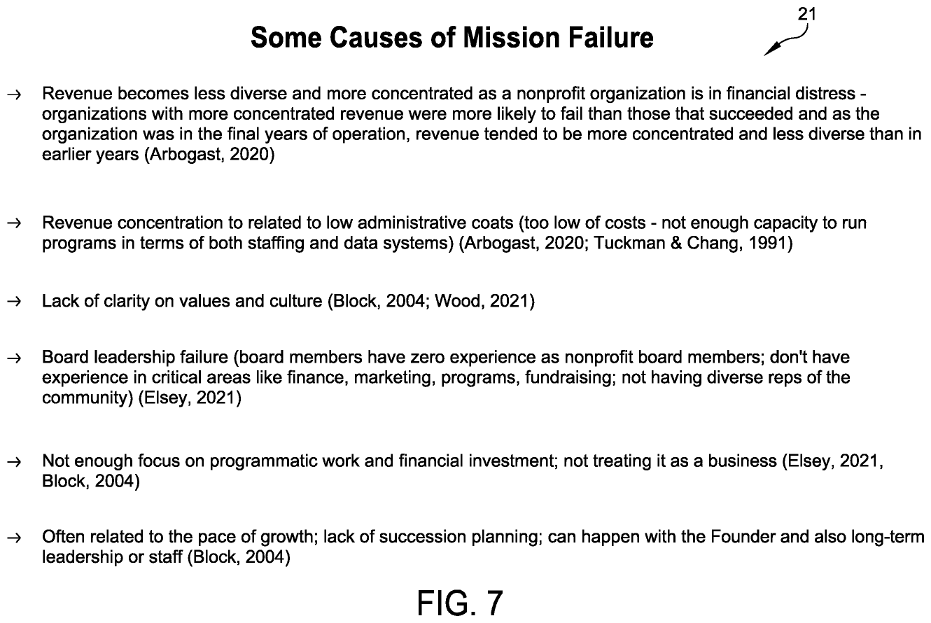

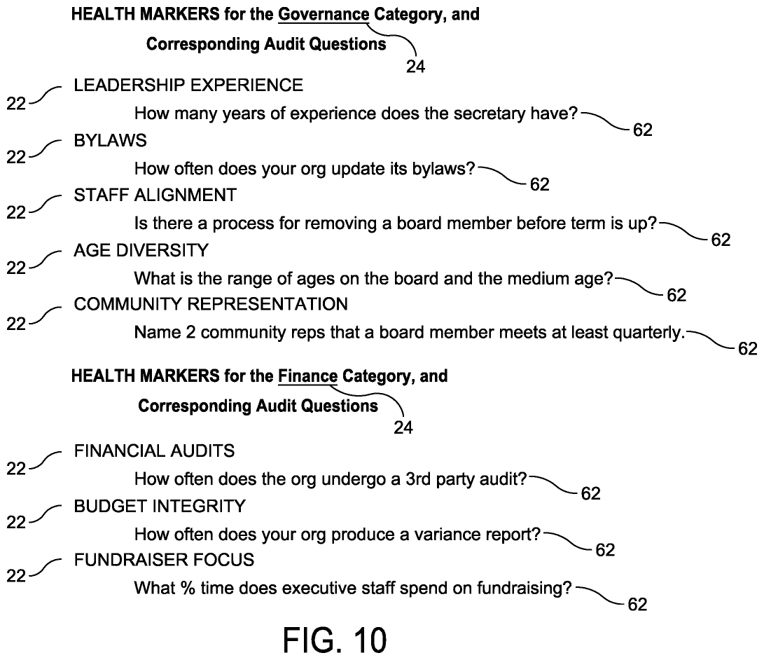

The sustainability research library 20 may then be configured to store a 3 dimensional matrix of the health markers 22 organized into marker categories 24 for each of multiple organizational types 34. For example, referring to FIG. 10, two categories 24 (governance and finance) may each contain several health markers 22 descriptive of that category 24, for a particular organizational type 34 (not shown). One (or more) corresponding audit questions 62 may then be associated with each marker 22 for surveying the impact of that marker on the scoring of the operational health. The origin of such a matrix of markers 22 and categories 24 may derive in part from market research such as shown in FIG. 7 in which various authors describe causes of mission failure. The market research may originate in work by Arbogast (published 2020), Block in 2004, Wood in 2021, Tuckman & Chan in 1991, and Elsey in 2021.

Referring to FIGS. 1-2 and 10, various forms of research 21 may be undertaken to identify the appropriate audit questions 62 to ask, and the most accurate scaling and weighting factors to apply in the scoring module 18. For example, mission sustainability may be measured by surveying a history of satisfaction within the stakeholder community of a particular NPO, and by looking for evidence of a stable mission fulfillment over time. Sustainability research on a large pool of NPOs of differing types may provide this correlation of positive operational behaviors and expertise with mission sustainability.

Continuing, sustainability research 21 may be stored as a matrix of multiple health markers 22 for each marker category 24 and for each organizational type 34. For example, the research database 20 of FIG. 1 shows a matrix of six marker categories 24 and fifteen health markers 22 for each of the categories 24, all for one organizational type 34. In addition, associated with each marker 22 may be one or more audit questions 62 for assessing the operational health around that marker. Typically, the audit question 62 may concern some operational behavior such as asking “How often is the succession plan reassessed?” or “What percent of the budget is allocated for continuing education for the staff?”. Sometimes the audit question 62 may be directed toward an aspect of experience, such as “How many years of professional leadership experience does the Vice President have?”. The audit questions may alternatively be formulated within the audit processor.

Referring now to FIGS. 1-2 and 5a-5c, in various embodiments, the audit answers 64 collected by the survey module 17 may be quantified and scaled by a scoring module (calculator) 18 within the audit processor 16. The quantified audit answers may be scaled in proportion to their influence on the operational health and for producing a composite sustainability score 50. The scoring 76 may further include aggregating and combining 79 each of the scaled audit answers into one of the multiple marker categories 24 for producing a category score 66 for each of the marker categories 24. Further, the method 11 may include weighting and combining the category scores 66 in proportion to their influence on the operational health for producing the composite sustainability score 50.

Continuing with FIGS. 1-2, in an embodiment, one audit answer 64 may relate to “BOD volunteer hours/month”, and may be quantified as follows. Assuming a $100,000 annual budget, a 10%·Budget target for the entire BOD, and 10 BOD members, we get an expected volunteering contribution/member of $100,000×10%/10 members=$1000 per year per member (ideal). If the national valuation for volunteering is $29.95/hour, and the member responds that they contribute 10 hours/year is their, then they are contributing $299.50 per year against a $1000 target, producing thereby a ‘Give and Get’ recommendation for that member of $1000−$299.50=$700.50. This amount may guide recommendations 67 to the organization 12 or the amount may be scaled according to benchmarks in the research library 20.

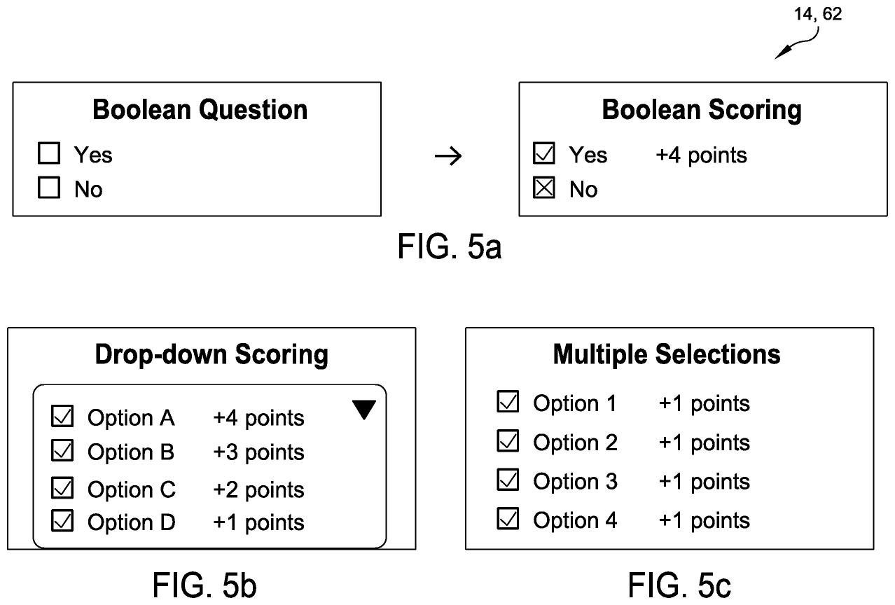

Audit answers 64 may be awarded a point value convenient to the audit method 11, and may include Boolean questions, drop-down scoring with varying point values, or multiple choice answers with equal point values (FIGS. 5a-5c). The point value may be dependent on the organizational type 34 for best prediction of mission sustainability, based on the other NPOs of similar organization type. The point values may be assigned by the scoring module 18 in coordination with the sustainability research library 20 and the organizational database 30. Alternatively, the sustainability research library 20 may store the audit questions 62 with point values for each of the multiple organizational types 34, sending the point values to the scoring module 18.

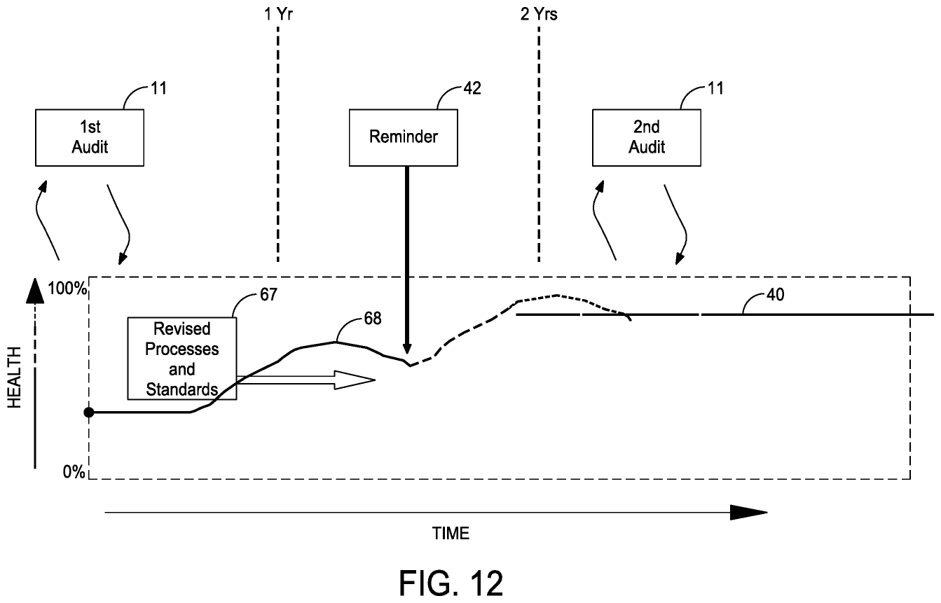

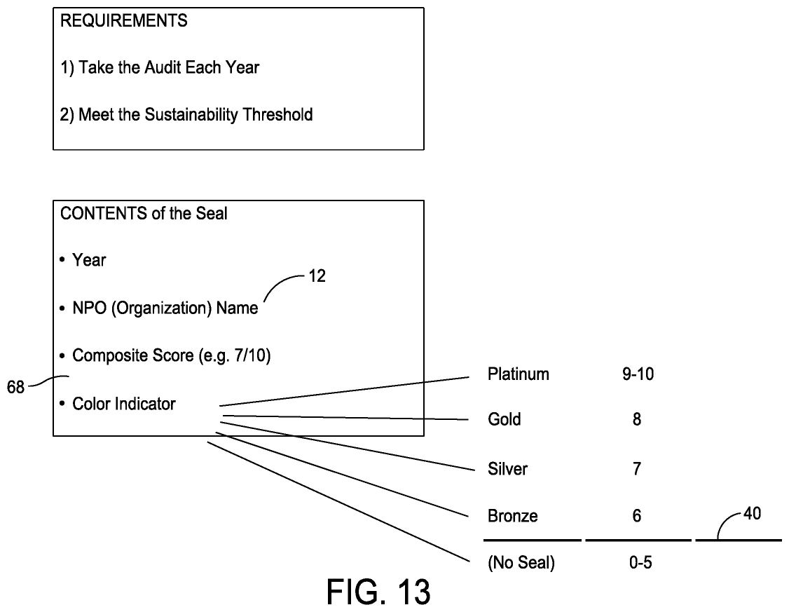

Continuing with FIGS. 1-2 and 12-13, in various embodiments, the method may further include electronically sending 50 an indication of the composite score 68 to the organization. The indication 68 may include at least one of a numerical rating (e.g. 270), the composite score 68, a letter grade (e.g. “A” or “B”), and a percentage relative to a 100% operational health (e.g. 64%). The method may further include certifying the non-profit organization 12 by making public the indication 68 of the organizational health when it exceeds a sustainability threshold 40 such as “6 out of 10” (FIGS. 12-13). The indication 68 may also be a seal of approval from the certifying body and may include a symbol of the certifying body and/or a color rating such as gold, silver, or bronze. Beneficially, the indication and/or certification may advertise to current and future donors that the organization is sustainable and healthy, worthy of their trust and financial contribution. After some time, the organization may decide to conduct a 2nd audit to see I they've improved or surpassed the sustainability threshold earning a certification.

Referring again to FIGS. 1-2, in various embodiments, presenting the audit questions 74 may include surveying the respondent 15 for one or more subjective ratings 39 of the operational health, where a validation database 36 linkable to the sustainability research library 20 may provide the corresponding survey questions 38. In a preferred embodiment, the respondent 15 may be surveyed for providing a subjective category rating 39 within one or more of the following marker categories 24 for validating the corresponding objective category scores 66: governance, finances, personnel and compensation, looking through a business lens, succession planning, and evidence of an established mission, vision, and values.

The audit processor 16 may be configured to compare 77 the subjective category ratings 39 to the corresponding category scores 66 and may adjust the scoring 18 to improve the accuracy of the composite score 68 when the ratings 39 and scores 66 differ. For example, the respondent 15 may be asked to rate the health 68 of the organization overall, and in the six categories 24, on a scale of 1-10. Then, for each category, the ratings 39 from all the respondents may be averaged to determine a correction multiplier to apply to the composite 68 and to the category 66 scores. Beneficially, a mismatch between the subjective assessment and the objective audit may guide a fine tuning of the audit method 11. Also, adding qualitative (subjective) assessments to the audit may uncover new or more inclusive perspectives. The subjective category ratings may be queried before the operational audit questions, afterwards, both before and after, or may be intermingled with the operational audit questions.

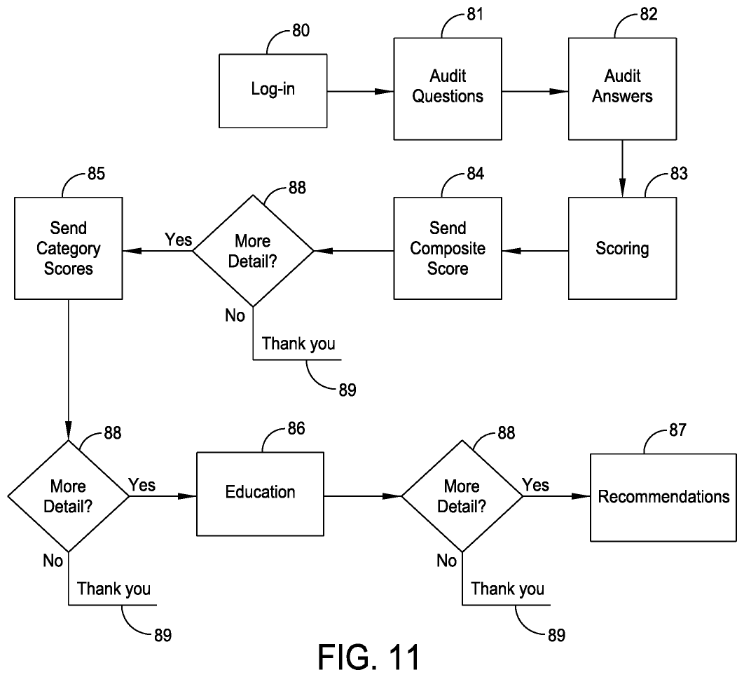

Referring to FIG. 11, in various tiered embodiments, the audit system 10 may provide two educational features. First, once login 80, posing audit questions 81, receiving audit answers 82, and scoring 83 have occurred, the composite score 68 may be electronically sent 84 to one or more constituents or respondents 15 in the organization 12. This may preferably be a free report. If the customer wants 88 more detail, the audit system 10 may electronically send 85 category scores 66 to the organization 12 in return for a fee, or a “thank you” email 89 may be sent. If the customer wants 88 educational detail, the audit system may be configured to electronically send 86 an explanation 67, through educational module 19 (FIG. 1), of WHY one or more of the following affects the operational health: one of the multiple marker categories 24, one of the operational behaviors, and a particular expertise of the BOD.

Continuing with FIGS. 1 and 11, these educational messages for the audit customer may be stored in the sustainability research library 20 for the particular organizational type 34 being audited. Should the customer want 88 additional educational detail, the audit system may be configured to electronically send 87 a recommendation 67 to the organization for HOW to improve one or more categories 24 of operational health, based on the sustainability research 21. The recommendation 67 may include modifying one of the operational behaviors and/or modifying a standard of expertise.

Recommendation messages 67 may be adjusted from their standard forms, based on the subjective validation ratings 39. For example, differences between the ratings 39 and the scores 66 may indicate an organizational lack of awareness of actual operational behaviors and expertise, where the objective scores are accurately predicting sustainability. By taking into account ‘blind spots’ in the subjective responses 39, the educational recommendations 67 may be adjusted to better meet the capacity of the staff and BOD to understand and implement the recommendations 67.

Referring now to FIGS. 1-2 and 12, after completing at least one health audit and receiving recommendations 67, the audit system 10 may be configured to send periodic maintenance messages 42 to the organization 12 for encouraging accountability to a set of operational behaviors and expertise standards adopted for improving one or more of the category scores 66. Gradually, with additional audits, the composite score 68 may rise above the certification threshold 40 and may merit a public certification of strong operational health. Beneficially, receiving friendly or inspiring reminders of the goals set after a first audit may maintain momentum in improving the operational health.

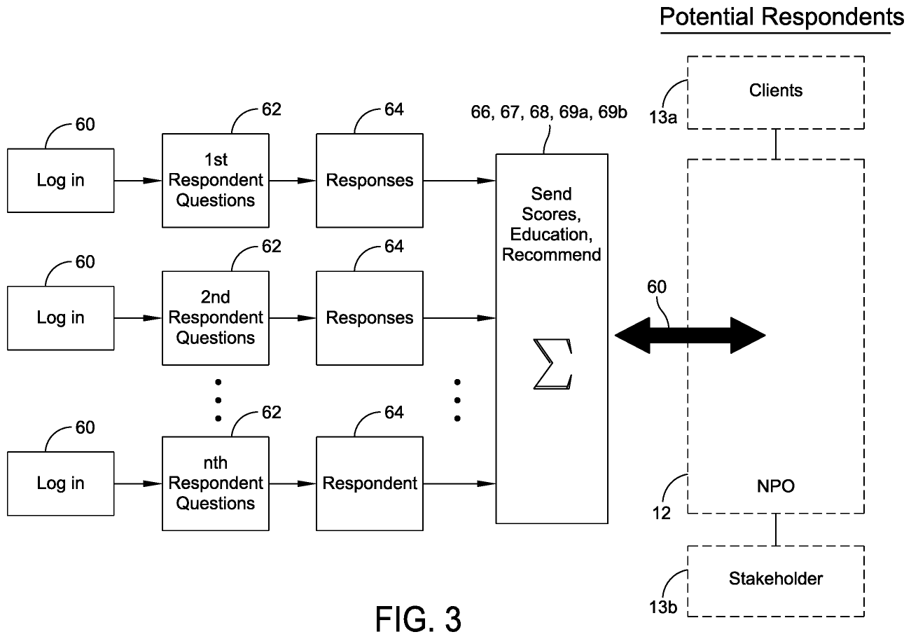

Elaborating now with FIGS. 1, 3 and 8-9, in various embodiments, the respondent 15 may be a member of the organization's 12 board or staff, a stakeholder 13b of the organization, a client 13a of the services provided, or other constituent (FIG. 3). Stakeholders 13b may include local government, partners in fundraising or outreach, and related businesses or other non-profit organizations. The audit processor 16 may select audit questions 62 which are within the capacity of the respondent 15 to give an informed answer 64. For example, a member of the business community that frequently collaborates with the organization 12 could be asked about the expertise of the board. And a client of the organization 12 could be asked about the stability of the service provided by the organization 12. But the two above questions sets may not be usefully exchanged.

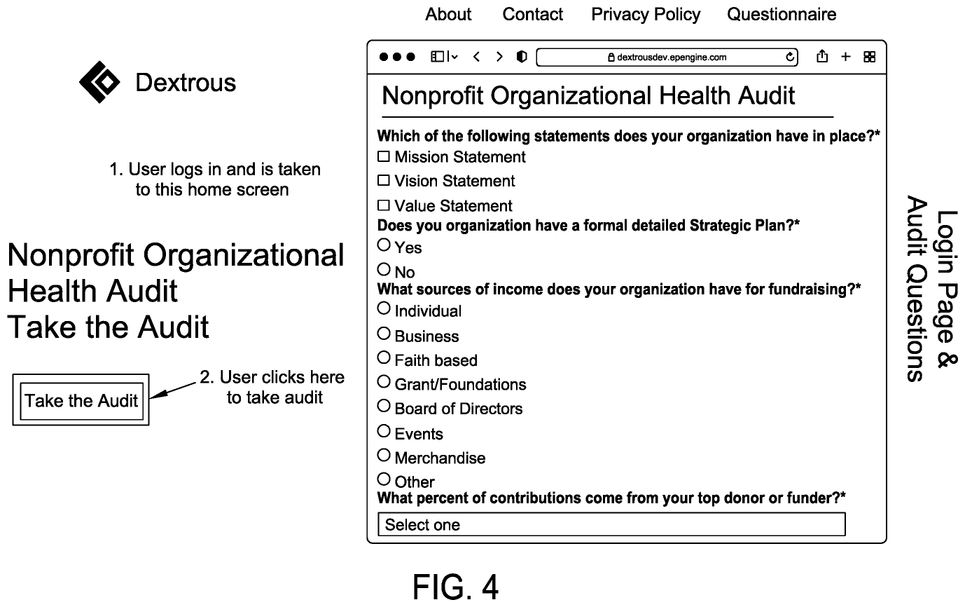

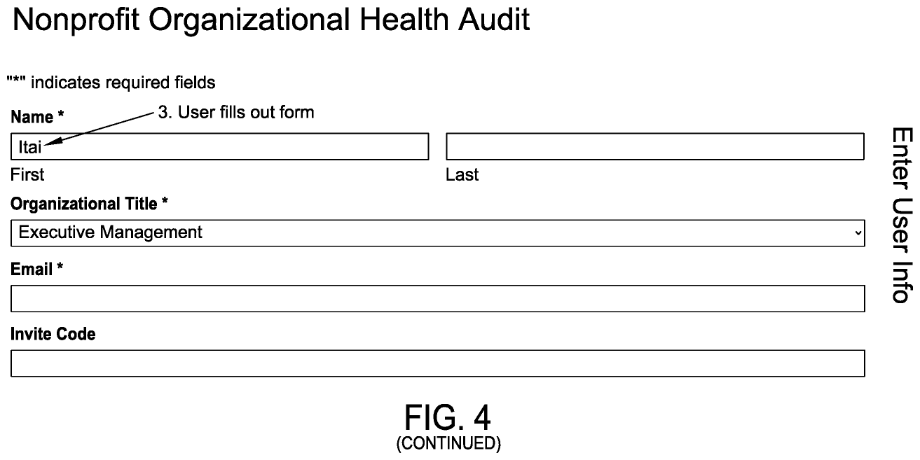

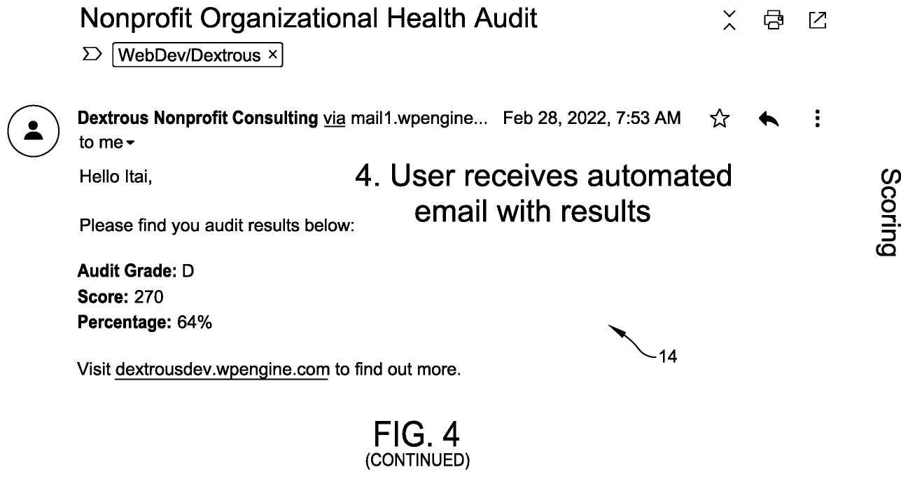

In one embodiment, the respondent 15 may discover, or be directed to, a home screen (FIG. 4) of the audit system 10 and be given an option to take the audit survey. The respondent 15 may be prompted to enter a respondent name, title, and email address. Optionally, an invite code 60 or password may be required to access the system 10, and the code 60 may be authorized or paid for by a customer within the non-profit organization 12. In a preferred embodiment (FIGS. 5a-5c), audit questions 62 may be multiple choice or Boolean (yes/no or true/false) in order to facilitate a quick survey and encourage participation in the audit. For example, the online audit may be designed to take 15 minutes to complete. Alternatively, a series of audit questions 62 may include textual answers and the audit may therefore take longer.

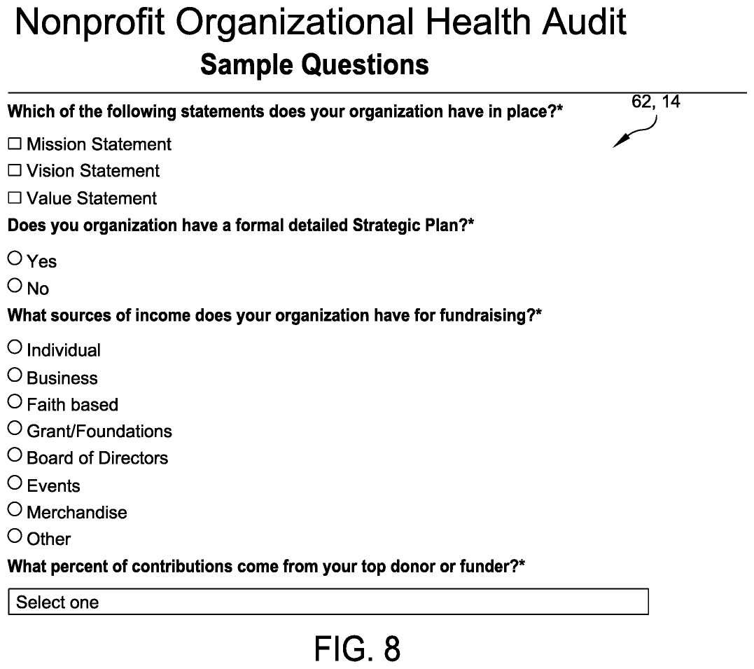

FIG. 8, in one embodiment, may illustrate one screenshot example of the online portal for asking the audit questions 62. Questions 62 relating to each of the marker categories (segments) may include the following examples: number of years of experience of members of the board of directors, a rating of leadership skills present in the organization, a percentage of an annual budget directed toward administration, a presence of a leadership succession planning, a percentage of annual revenue coming from a largest source of the revenue, and a presence of a mission statement constructively defining core values and a desired work culture.

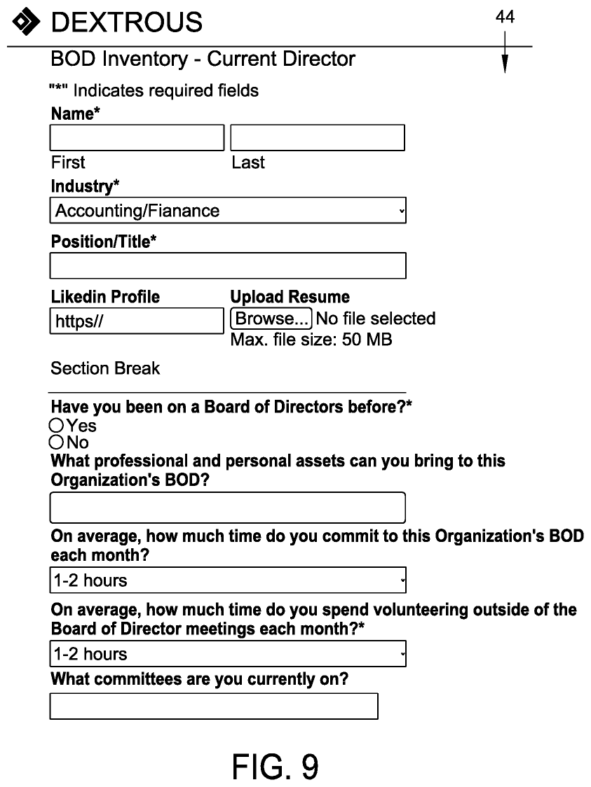

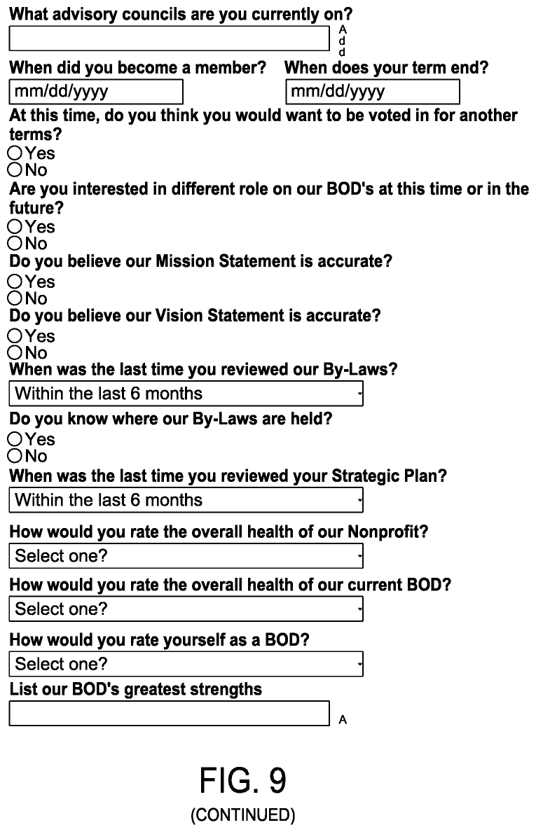

FIG. 9, in another embodiment, may illustrate an online ‘dashboard’ directing audit questions 62 toward a specific respondent 15—in this case, a BOD Inventory directed toward a current director of the Board. The BOD inventory may request work experience, hours worked per month, committees they belong to, their term of service, an opinion of the mission and vision statements, their familiarity with the strategic plan, a personal performance rating, a rating of organizational health, and the personal and professional assets they bring to the Board. This questionnaire may be an individual diagnostic tool, distinct from the organizational health audit (index), for assessing a particular respondent's expertise, activities, and opinions as measured against the organizational scores (66, 68, 69a, 69b). The organizational scores (66, 68, 69a, 69b), based on a survey of many stakeholders 13b, staff, and board members, may form a benchmark against which the inventory is evaluated. The BOD Inventory may then be used to screen a prospective or current BOD member for their qualifications to serve the organization 12, or to form recommendations to build up certain skills.

A similar BOD inventory may be sent tor prospective board members using a mix of questions similar to those for the current Board member. An organizational dashboard (not shown) may also be offered to a respondent 15 for requesting organizational descriptors 32 such as listing active committees, listing advisory councils, reporting years in operation, annual budget, term limits on board members, and #paid employees.

Now turning to FIGS. 1-3, in an embodiment, the audit questions 62 may be presented to multiple respondents 15 associated with “the whole organization” 12 for producing an aggregate category score 69a for each of the marker categories 24 and an aggregate composite score 69b for the whole organization 12. The scaled audit answers 64 from the multiple respondents 15 may be combined by the audit processor 16 to produce the aggregate scores 69a and 69b of the operational health, where the multiple respondents 15 belong to one or more of the staff, the BOD, stakeholders 13b of the organization 12, and clients 13a of the services of the organization 12. For example, the category 66 and the composite 68 scores from each of multiple respondents 15 may be averaged to produce the aggregate scores 69a and 69b. Additionally, category scores 66, educational data 67, and composite scores 68 from each respondent 15 may also be provided to one or more respondents 15 or constituents of the organization 12. Each of the multiple respondents 15 may be sent an invite code 60 for electronically accessing the audit questions 62.

Although the above embodiments have been described in language that is specific to certain structures, elements, compositions, and methodological steps, it is to be understood that the technology defined in the appended claims is not necessarily limited to the specific structures, elements, compositions and/or steps described. Rather, the specific aspects and steps are described as forms of implementing the claimed technology. Since many embodiments of the technology can be practiced without departing from the spirit and scope of the invention, the invention resides in the claims hereinafter appended.

What is claimed is:

1. A method for auditing and automatically scoring an operational health of a non-profit organization (NPO) providing services according to a mission, the organization having a board of directors (BOD) for providing governance and a staff for providing the services, the method comprising:
presenting to a respondent of the organization a series of audit questions configured to measure the impact of certain health markers on the operational health of the organization and based on sustainability research, each of the health markers referring to an operational behavior or an expertise within the organization;
receiving from the respondent audit answers corresponding to the series of audit questions;
quantifying and scaling each of the audit answers in proportion to their influence on the operational health;
combining the scaled audit answers to produce a composite sustainability score of the operational health;
electronically sending an indication of the composite score to the organization; and
where the composite sustainability score predicts an ability of the organization to indefinitely sustain its mission.

2. The method of claim 1, further comprising:
aggregating and combining each of the scaled audit answers into one of multiple marker categories of the health markers, the multiple categories collectively assessing the operational health while providing discrimination, the combining producing a category score for each of the multiple marker categories, and weighting and combining the category scores in proportion to their influence on the operational health for producing the composite sustainability score.

3. The method of claim 2, wherein:
the multiple marker categories describe two or more of the following dynamics: governance, finances, personnel and compensation, looking through a business lens, succession planning, and evidence of an established mission, vision, and values.

4. The method of claim 2, further comprising:
electronically sending an explanation of why one or more of the following affects the operational health: one of the multiple marker categories, one of the operational behaviors, and a particular expertise of the BOD.

5. The method of claim 2, further comprising:
electronically sending a recommendation to the organization for improving the operational health, based on the sustainability research and the category scores, where the recommendation includes modifying one of the operational behaviors and/or modifying a standard of expertise.

6. The method of claim 2, further comprising:
presenting to a prospective or a future BOD member a BOD inventory questionnaire for assessing a suitability of the BOD member to serve the organization, the results of the inventory being benchmarked against weaknesses identified in the organization health audit, where the BOD inventory queries one or more of a personal expertise, an awareness of current operational behaviors in the organization, a subjective rating of organizational health, and a self-assessment.

7. The method of claim 1, further comprising:
the audit questions including requesting one or more of the following descriptors of the organization for classifying an organizational type, the organization type for choosing the audit question based on the sustainability research of similar other NPOs: an annual operating budget, years of operation, a title of the organization, a non-profit legal status, services provided, an area of focus or mission, a governance model of the BOD, a number of paid staff, a number of volunteer staff, and a location of headquarters.

8. The method of claim 1, further comprising:
collecting the sustainability research on a large number of other NPOs similar to the non-profit organization in terms of one or more of the following organizational descriptors, the research including identifying the health markers which correlate best to a history of mission sustainability: an annual operating budget, years of operation, a title of the organization, a non-profit legal status, services provided, an area of focus or mission, a governance model of the BOD, a number of paid staff, a number of volunteer staff, and a location of headquarters.

9. The method of claim 1, further comprising:
storing the sustainability research in a sustainability research library.

10. The method of claim 1, further comprising:
querying the respondent for a subjective category rating of the operational health within one or more of the following marker categories for validating the corresponding objective category score: governance, finances, personnel and compensation, looking through a business lens, succession planning, and evidence of an established mission, vision, and values.

11. The method of claim 10, further comprising:
comparing the category ratings to the corresponding category scores and scaling the category and the composite scores by a multiplier derived from the average category ratings from all the respondents in order to improve the accuracy of the composite sustainability score.

12. The method of claim 1, wherein:
the indication is the composite score including at least one of a numerical rating, a letter grade, and a percentage relative to a 100% operational health.

13. The method of claim 1, further comprising:
certifying the non-profit organization by making public the indication of the organizational health when exceeding a sustainability threshold.

14. The method of claim 13, wherein:
the indication is a seal of approval and includes a grade or a color rating.

15. The method of claim 1, further comprising:
presenting the audit questions to multiple respondents associated with the organization and combining the scaled audit answers from the multiple respondents to produce aggregate composite and category scores of the operational health, where the multiple respondents belong to one or more of the staff, the BOD, stakeholders of the organization, and clients of the services of the organization.

16. The method of claim 15, further comprising:
providing to each of the multiple respondents an invite code for accessing the audit questions.

17. The method of claim 1, further comprising:
after completing at least one health audit, sending periodic maintenance messages to the organization for encouraging accountability to a set of operational behaviors and expertise standards adopted for improving the composite sustainability score.

18. The method of claim 1, wherein:
the audit questions include asking about one or more of the following: number of years of experience of members of the board of directors, a rating of leadership skills present in the organization, a percentage of an annual budget directed toward administration, a presence of a leadership succession planning, a percentage of annual revenue coming from a largest source of the revenue, and a presence of a mission statement constructively defining core values and a desired work culture.

19. An audit system for auditing and automatically scoring an operational health of a non-profit organization (NPO) providing services according to a mission, the organization having a board of directors (BOD) for providing governance and a staff for coordinating with the BOD to provide the services according to the mission, the system comprising:
a user interface configured for communicating with a respondent associated with the organization;
an audit processor configured to electronically send audit questions to and receive corresponding audit answers from the respondent through the user interface, the audit questions for measuring the impact of certain health markers on the operational health and based on sustainability research, each of the audit answers illuminating an operational behavior and/or an expertise within the organization;
an organizational database connected to the audit processor and configurable to store organizational descriptors for classifying the organization and other NPOs having a similar organization type;
a sustainability research library connected to the audit processor and configured to store the sustainability research including a correlation between the health markers indicative of the operational health and a history of mission sustainability for each of the other NPOs;
a scoring calculator within the audit processor and configurable to quantify, scale, and combine the audit answers for producing a composite sustainability score quantifying the operational health; and
where the organizational descriptors include one or more of an annual operating budget, years of operation, a title of the organization, a non-profit legal status, services provided, an area of focus or mission, a governance model of the BOD, a number of paid staff, a number of volunteer staff, and a location of headquarters.

20. The system of claim 19, further comprising:
a validation database connected to the audit processor and linkable to the sustainability research library for providing survey questions and collecting a corresponding subjective rating of the operational health from the respondent, the processor configurable to quantify the subjective rating and augment the composite score when the quantified rating and the composite score differ.

21. The system of claim 19, further comprising:
a sustainability threshold, where the audit system is configured to certify the non-profit organization by making public an indication of the composite score when it exceeds the sustainability threshold.
